(19) United States
(12) Patent Application Publication
(10) Pub. No.: US 2024/0155579 A1
(43) Pub. Date: May 9, 2024

(54) CHANNEL STATE INFORMATION FEEDBACK AND PRECODING FOR SUPPRESSING INTERFERENCE

(71) Applicant: MEDIA TEK INC., Hsinchu (TW)

(72) Inventor: Lung-Sheng Tsai, Hsinchu (TW)

(21) Appl. No.: 18/385,460

(22) Filed: Oct. 31, 2023

Related U.S. Application Data
(60) Provisional application No. 63/382,891, filed on Nov. 9, 2022.

(51) Int. Cl. H04W 72/0453; H04B 7/0456; H04B 7/06; H04W 24/08; H04W 72/542

(52) U.S. Cl. CPC H04W 72/0453; H04B 7/0456; H04B 7/0626; H04W 24/08; H04W 72/542

(57) ABSTRACT

In an aspect of the disclosure, a method, a computer-readable medium, and an apparatus are provided. The apparatus may be a UE. The UE receives data signals originated from a base station. The data signals are transmitted by the base station on first frequency resources and not on second frequency resources. The UE measures references signals transmitted from the base station on the second frequency resources. The UE selects, based on the measured reference signals, zero or more basis vectors that span an image space of a channel matrix between the UE and the base station on the second frequency resources or a null space of the channel matrix between the UE and the base station on the second frequency resources. The UE generates channel state information including indications the selected zero or more basis vectors. The UE transmits the channel state information to the base station.

### CROSS-REFERENCE TO RELATED APPLICATION(S)

This application claims the benefits of U.S. Provisional Application Ser. No. 63/382,891, entitled “CSI FEEDBACK AND PRECODING FOR SUPPRESSING INTERFERENCE” and filed on Nov. 9, 2022, which is expressly incorporated by reference herein in its entirety.

### BACKGROUND

### Field

The present disclosure relates generally to communication systems, and more particularly, to techniques of channel state information (CSI) feedback and precoding for suppressing interference.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE receives data signals originated from a base station. The data signals are transmitted by the base station on first frequency resources and not on second frequency resources. The UE measures references signals transmitted from the base station on the second frequency resources. The UE selects, based on the measured reference signals, zero or more basis vectors that span an image space of a channel matrix between the UE and the base station on the second frequency resources or a null space of the channel matrix between the UE and the base station on the second frequency resources. The UE generates channel state information including indications the selected zero or more basis vectors. The UE transmits the channel state information to the base station.

In an aspect of the disclosure, a method, a computer-readable medium, and an apparatus are provided. The apparatus may be a base station. The base station transmits data signals to a user equipment (UE) on first frequency resources and not on second frequency resources. The base station transmits reference signals on the second frequency resources. The base station receives, from the UE, channel state information including an indication of zero or more basis vectors that span an image space of a channel matrix between the base station and the UE on the second frequency resources or a null space of the channel matrix between the UE and the base station on the second frequency resources. The base station selects, based on the received channel state information, one or more precoding vectors. The base station communicates with another UE on the second frequency resources using the one or more selected precoding vectors.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric subframe.

FIG. 6 is a diagram showing an example of an UL-centric subframe.

FIG. 7 is a diagram illustrating communications between a base station and a UE via a repeater.

FIG. 8 is a flow chart of a method (process) for reporting channel state information.

FIG. 9 is a flow chart of a method (process) for determining, based on CSI received from one UE, precoding vectors for transmitting data to another UE.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

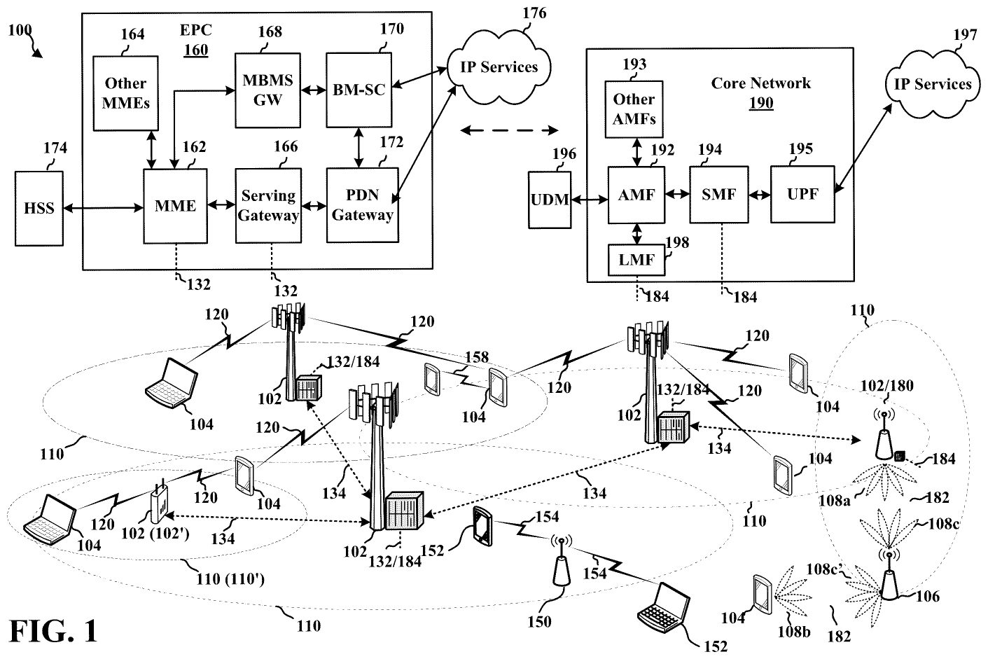

FIG. 1 is a diagram illustrating an example of a wireless communications system and an access network 100. The wireless communications system (also referred to as a wireless wide area network (WWAN)) includes base stations 102, UEs 104, and a core network 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the core network 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the core network 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 1 10. For example, the small cell 102′ may have a coverage area 110′ that overlaps the coverage area 1 10 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The core network 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the core network 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the core network 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

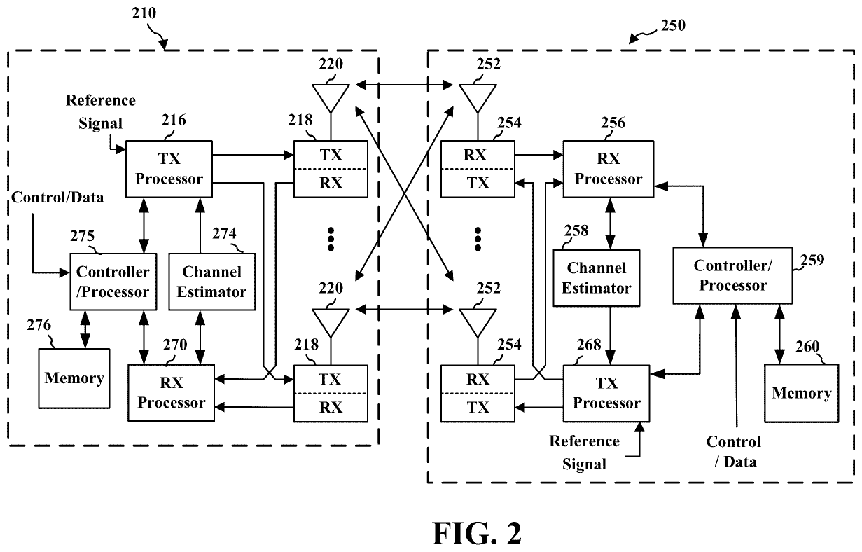

FIG. 2 is a block diagram of a base station 210 in communication with a UE 250 in an access network. In the DL, IP packets from the core network 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the core network 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the core network 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

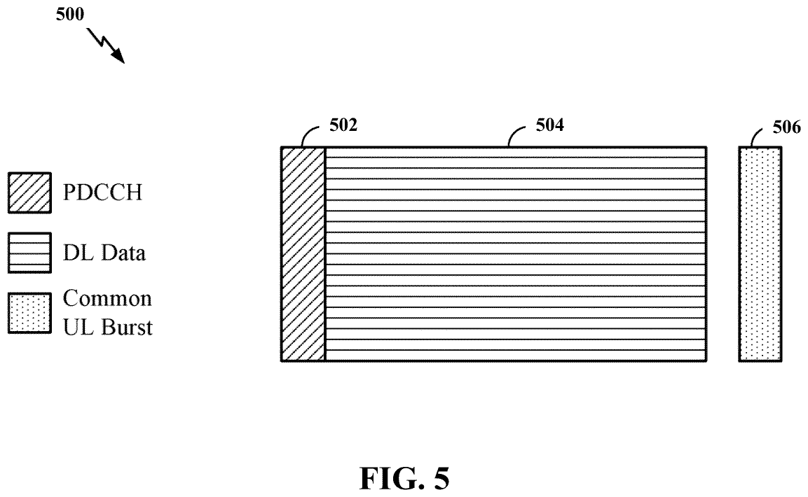

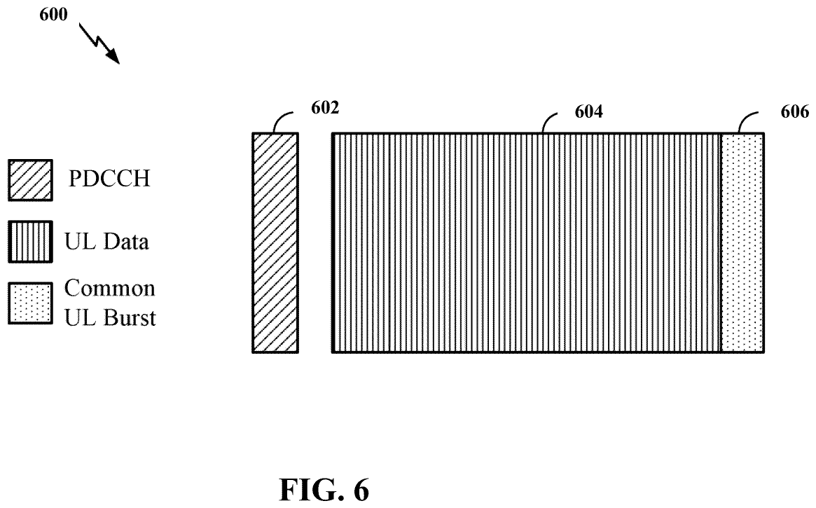

A single component carrier bandwidth of 100 MHZ may be supported. In one example, NR resource blocks (RBs) may span 12 sub-carriers with a sub-carrier bandwidth of 60 kHz over a 0.125 ms duration or a bandwidth of 15 kHz over a 0.5 ms duration. Each radio frame may consist of 20 or 80 subframes (or NR slots) with a length of 10 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

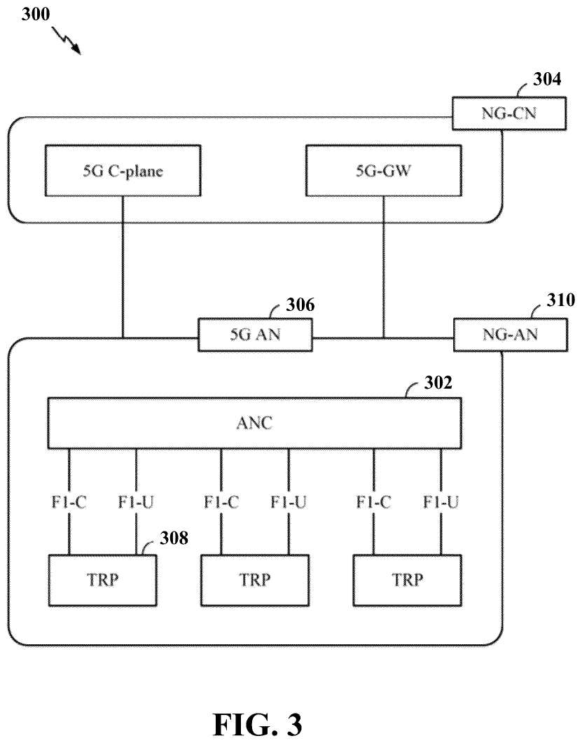

FIG. 3 illustrates an example logical architecture 300 of a distributed RAN, according to aspects of the present disclosure. A 5G access node 306 may include an access node controller (ANC) 302. The ANC may be a central unit (CU) of the distributed RAN 300. The backhaul interface to the next generation core network (NG-CN) 304 may terminate at the ANC. The backhaul interface to neighboring next generation access nodes (NG-ANs) may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

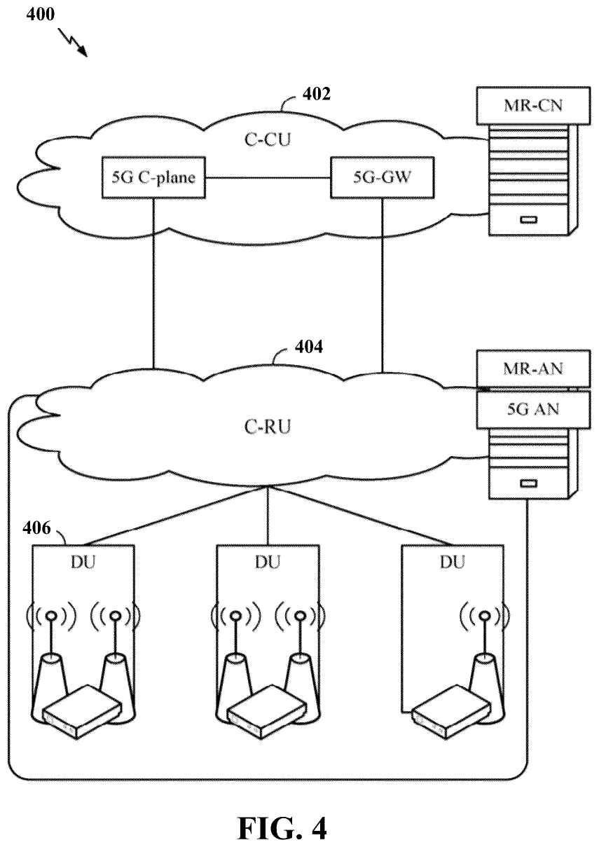

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric subframe. The DL-centric subframe may include a control portion 502. The control portion 502 may exist in the initial or beginning portion of the DL-centric subframe. The control portion 502 may include various scheduling information and/or control information corresponding to various portions of the DL-centric subframe. In some configurations, the control portion 502 may be a physical DL control channel (PDCCH), as indicated in FIG. 5. The DL-centric subframe may also include a DL data portion 504. The DL data portion 504 may sometimes be referred to as the payload of the DL-centric subframe. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric subframe may also include a common UL portion 506. The common UL portion 506 may sometimes be referred to as an UL burst, a common UL burst, and/or various other suitable terms. The common UL portion 506 may include feedback information corresponding to various other portions of the DL-centric subframe. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

FIG. 6 is a diagram 600 showing an example of an UL-centric subframe. The UL-centric subframe may include a control portion 602. The control portion 602 may exist in the initial or beginning portion of the UL-centric subframe. The control portion 602 in FIG. 6 may be similar to the control portion 502 described above with reference to FIG. 5. The UL-centric subframe may also include an UL data portion 604. The UL data portion 604 may sometimes be referred to as the pay load of the UL-centric subframe. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe may also include a common UL portion 606. The common UL portion 606 in FIG. 6 may be similar to the common UL portion 606 described above with reference to FIG. 6. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such side link communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

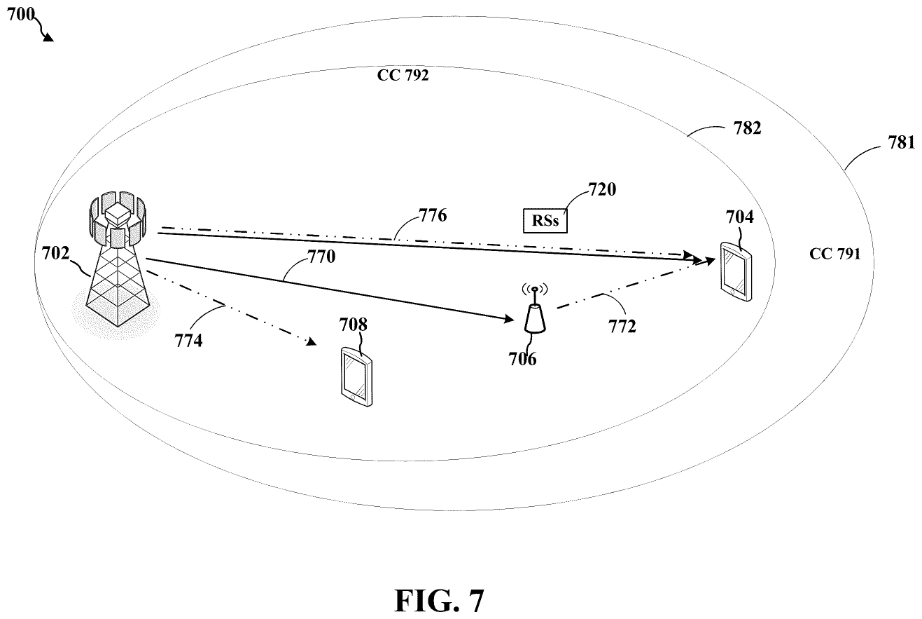

FIG. 7 is a diagram 700 illustrating communications between a base station 702 and a UE 704 via a repeater 706. More specifically, the repeater 706 is placed between the base station 702 and the UE 704. The base station 702 is equipped with N_{T} (e.g., 32) transmission antennas. The UE 704 is equipped with N_{R} (e.g., 4) reception antennas. The repeater 706 is equipped with N_{T}^{REP} (e.g., 4) transmission antennas and N_{R}^{REP} (e.g., 4) reception antennas. In certain configurations, the same physical antenna may function as a reception antenna and a transmission antenna. The UE 704 may be considered as a master device. The repeater 706 may be considered as slave devices. The repeater 706 may be a UE, a wireless router, or other wireless device that performs the functions infra. The UE 704 and the repeaters 706 are located within the coverage area 781 of the CC 791 and the coverage 782 of the CC 792.

The repeater 706 may receive RF signals transmitted from base station 702 through a channel 770 that may utilize the CC 791. As described infra, the base station 702 may allocate the CC 792 (or other resources) for communications between repeater 706 and the UE 704. Accordingly, the repeater 706 can amplify and forward the received RF signals to the UE 704 through a channel 772 that may utilize the CC 792.

A UE 708 is located within the coverage 782 of the CC 792. The base station 702 communicates with the UE 708 through a channel 774 that utilizes the CC 792. Specifically, the base station 702 transmits signals x_{intf} to the UE 708 on the CC 792.

The UE 704 may receive the signals x_{intf} from the base station 702 through a channel H_{4×32}^{(gNB→UE)}. The channel 772 between the repeater 706 and the UE 704 on the CC 792 may be represented as H_{4×4}^{(REP→UE)}. The total signals r_{4×1} received at the UE 704 on the CC 792 is the sum of the data signals r_{4×1}^{(REP→UE)} received from the repeater 706 and the signals r_{4×1}^{(gNB→UE)} received from the base station 702. The signals r_{4×1}^{(gNB→UE)} contain data directed to the UE 708 and is considered as interference to the UE 704. The total signals r_{4×1} on the CC 792 may be represented as follows:

r_{4×1}=r_{4×1}^{(REP→UE)}+r_{4×1}^{(gNB→UE)}

=H_{4×4}^{(REP→UE)}·P_{4×n}_{_{S}}·x_{S}+H_{4×32}^{(gNB→UE)}·P_{32×n}_{_{L}}·x_{intf}+n,

where x_{S} is the signal transmitted from the repeater 706 repeater to the UUE 704, x_{intf} is the interference signal transmitted from the base station, n is a noise signal, P_{4×n}_{_{S}} is the precoder used by the repeater 706 to transmit data to the UE 704, P_{32×n}_{_{L}} is the precoder used by the base station 702 to transmit data to the UE 708, n s is the number of layers of xₛ and n_{L} is the number of layers of x_{intf}.

The goal is to minimize the interference term r_{4×1}^{(gNB→UE)} by having the base station 702 choose a precoder P_{32×n}_{_{L}} that results in H_{4×32}^{(gNB→UE)}·P_{32×n}_{_{L}}≈0. This can be achieved if the UE 704 provides channel state information to the base station 702 about the channel H_{4×32}^{(gNB→UE)} on the CC 792.

The null space or kernel of a matrix H contains all vectors x that satisfy:

Hx=0

In other words, the null space of H is the set of vectors that get mapped to the zero vector when multiplied by H.

For the channel matrix H_{4×32}^{(gNB→UE)} from the base station 702 to the UE 704, its null space ker (H_{4×32}^{(gNB→UE)}) contains all 32-dimensional precoding vectors P_{32×1} that satisfy:

H_{4×32}^{(gNB→UE)}·P_{32×1}=0_{4×1})

where 0_{4×1} is a 4×1 zero vector. In other words, the null space contains all precoders that result in zero interference leakage through the channel 776 to the UE 704 when transmitted from the base station 702.

The UE 704 may provide information about ker (H_{4×32}^{(gNB→UE)}) to the base station 702, so the base station 702 can choose a precoder P_{32×n}_{_{L}} from this null space to avoid interfering with the UE.

In general, the UE 704 may receive interference signals x_{intf} from the base station 702 on the CC 792 while receiving data signals from the repeater 706. To avoid causing interference to the UE 704 when communicating with other UEs one the CC 792, the base station 702 can choose precoding vectors P_{N}_{_{T}}_{×1} from the null space (kernel) of the channel matrix H_{N}_{_{R}}_{×N}_{_{T}}^{(gNB→UE)} from the base station 702 to UE 704, denoted as ker(H_{N}_{_{R}}_{×N}_{_{T}}^{(gNB→UE)}).

The null space ker(H_{N}_{_{R}}_{×N}_{_{T}}^{(gNB→UE)}) contains all N_{T}-dimensional precoding vectors P_{N}_{_{T}}_{×1} that satisfy:

H_{N}_{_{R}}_{×N}_{_{T}}^{(gNB→UE)}P_{N}_{_{T}}_{×1}=0_{N}_{_{R}}_{×1},

where 0_{N}_{_{R}}_{×1} is a N_{R}×1 zero vector. In other words, the null space contains all precoders that result in zero interference leakage through the channel H_{N}_{_{R}}_{×N}_{_{T}}^{(gNB→UE)} when transmitted from the base station 702.

The UE 704 can feedback information about ker(H_{N}_{_{R}}_{×N}_{_{T}}^{(gNB→UE)}) to the base station 702, so the base station 702 can avoid causing interference to the UE 704 on the CC 792 by selecting precoding vectors from this null space.

The dimension of the null space ker(H_{N}_{_{R}}_{×N}_{_{T}}^{(gNB→UE)}), denoted as dim (ker(H_{N}_{_{R}}_{×N}_{_{T}}^{(gNB→UE)})) is N_{T}−N_{R}. In this example, dim (ker(H_{4×32}^{(gNB→UE)}))=32−4=28. The image of H_{N}_{_{R}}_{×N}_{_{T}}^{(gNB→UE)}, denoted as im(H_{N}_{_{R}}_{×N}_{_{T}}^{(gNB→UE)}), is the vector space containing all vectors x such that H_{N}_{_{R}}_{×N}_{_{T}}^{(gNB→UE)} x≠0. The dimension of the image space is typically much smaller than the dimension of the null space. For example, dim (im(H_{4×32}^{(gNB→UE)}))=N_{R}=4.

Instead of feeding back the basis vectors of the large null space ker(H_{N}_{_{R}}_{×N}_{_{T}}^{(gNB→UE)}), the UE 704 can feed back the basis vectors of the smaller image space im(H_{N}_{_{R}}_{×N}_{_{T}}^{(gNB→UE)}) to the base station 702, resulting in less feedback overhead. The base station 702 can then avoid selecting precoders in the image space, since those would cause interference to the UE.

The legacy CSI framework allows the UE 704 to feedback information about the channel image im (H_{(4×32)}^{(gNB→UE)}) or channel null space ker (H_{(4×32)}^{(gNB→UE)}) of the channel matrix H_{(4×32)}^{(gNB→UE)} from the base station 702 to the UE 704 in CC 792.

However, the spatial resolution of the legacy codebook used for CSI feedback is typically not high enough to accurately represent the image space or null space when the rank is high. For example, when the rank is 4 in this 4×32 system, the legacy codebook has poor spatial resolution.

To improve upon the legacy method, higher resolution representations of the spatial domain vectors are needed to accurately describe the image space im (H_{(4×32)}^{(gNB→UE)}).

One way to achieve higher resolution is to allow the UE 704 to arbitrarily select basis vectors from an oversampled FFT codebook to describe the channel image im (H_{(4×32)}^{(gNB→UE)}) providing finer spatial resolution compared to the legacy codebook use.

In the 4×32 system of this example with the UE 704 equipped with 4 antennas and the base station 702 equipped with 32 antennas, the channel matrix from the base station 702 to the UE 704 in CC 792 is denoted as H_{(4×32)}^{(gNB→UE)}.

The legacy codebook used for CSI feedback from the UE 704 to the base station 702 constrains the UE to select basis vectors with uniform spacing or other predefined spacing arrangements. This results in poor spatial resolution for describing the 4-dimensional image space im (H_{(4×32)}^{(gNB→UE)}) when the rank is 4.

To improve the spatial resolution, the proposed enhancement allows the UE 704 to arbitrarily select basis vectors from an oversampled FFT codebook without the uniform spacing or other spacing constraints. This provides finer quantization of the spatial domain and higher resolution description of the image space basis vectors. As such, the UE 704 can provide a more accurate characterization of the channel to the base station 702. The base station 702 can then more reliably choose precoders in the null space to avoid interference when communicating with UEs like 704 in CC 792.

By feeding back higher resolution descriptions of the image space or null space using the proposed enhancements, the base station 702 can more accurately null its transmissions to avoid interfering with the UE 704 communicating in CC 792.

As described supra, the base station 702 is equipped with N_{T}^{gNB} B transmit antennas and the UE 704 is equipped with N_{R} receive antennas, the channel matrix from the base station 702 to the UE 704 is denoted as H_{(N}_{_{R}}_{×N}_{_{T}}_{^{gNB}}₎^{(gNB→UE)}. The dimension of the image space of this channel matrix be K=dim(im(H_{(N}_{_{R}}_{×N}_{_{T}}_{^{gNB}}₎^{(gNB→UE)})). K may be N_{R}. In this example, the base station 702 transmits reference signals 720 on the CC 792.

In a first technique, the UE 704 measures the reference signals 720 and selects, from a oversampled 2D DFT codebook, K basis vectors v₁, . . . , v_{K} at which the reference signals 720 have the best qualities. The image space may be represented as:

im(H_{N}_{_{R}}_{×N}_{_{T}}^{(gNB→UE)})=span{v₁, . . . ,v_{K}}.

The oversampled 2D DFT codebook may be the codebook defined in “3GPP TS 38.214 V17.3.0 (2022-09) Technical Specification 3rd Generation Partnership Project; Technical Specification Group Radio Access Network; NR; Physical layer procedures for data (Release 17)” (3GPP TS 38.214). As described supra, the selection of basis vectors from a codebook is not bound by a spacing constraint.

To report CSI describing these K selected basis vectors, the UE 704 can feedback K rank-1 PMIs, with each vᵢ represented by one rank-1 PMI. Therefore, with the rank constraint set to RI=min(N_{R}, N_{T}^{gNB}) which equals K, the UE 704 will report K rank-1 PMIs to convey the K basis vectors v₁, . . . , v_{K} that span the image space im(H_{(N}_{_{R}}_{×N}_{_{T}}_{^{gNB}}₎^{(gNB→UE)}). This allows the PMI report to capture information about the image space basis vectors under the framework of legacy CSI reporting.

In this example, N_{R}=4 is the number of receive antennas at the UE 704. N_{T}^{gNB}=32 is the number of transmit antennas at the base station 702. The channel matrix from base station 702 to UE 704 is H_{(4×32)}^{(gNB→UE)}. The dimension of the image of H_{(4×32)}^{(gNB→UE)} is min(N_{R}, N_{T}^{gNB})=4.

The UE 704 to always report a rank-4 CSI (the maximum rank possible) even if the actual channel rank is smaller. That is, the UE 704 feedbacks a CSI report with rank constraint RI=4. The associated PMI report tries to capture 4 basis vectors v₁, v₂, v₃, v₄ that span im (H_{(4×32)}^{(gNB→UE)}). Even though actual channel rank may be <4, the UE 704 describes im (H_{(4×32)}^{(gNB→UE)}) using 4 basis vectors.

From a rank-4 CSI/PMI (the maximum rank possible), the base station 702 can better understand the subspace causing interference, compared to lower rank feedback. This enables more reliable interference avoidance.

In a second technique, the UE 704 can feedback information about the image space by reporting M basis column vectors that span im(H_{(N}_{_{R}}_{×N}_{_{T}}_{^{gNB}}₎^{(gNB→UE)}) where

0≤M≤min(N_{R},N_{T}^{gNB}).

The value of M can also be reported by the UE 704 to indicate how many basis vectors are described.

If M=0, it means the UE 704 is almost out-of-coverage in the frequency channel CC2. In this case, the UE 704 does not need to feedback any vector about the image space im(H_{(N}_{_{R}}_{×N}_{_{T}}_{^{gNB}}₎^{(gNB→UE)}) but simply reports M=0.

Therefore, with the second technique, the UE 704 reports M basis vectors to partially characterize the image space, where M can range from 0 to min(N_{R}, N_{T}^{gNB}) depending on the channel conditions. Reporting M=0 indicates no need for image space feedback due to weak channel conditions.

To report CSI describing these M selected basis vectors, the UE 704 can feedback M rank-1 PMIs, with each vᵢ represented by one rank-1 PMI. That is, the UE 704 will report M rank-1 PMIs to convey the M basis vectors v₁, . . . , v_{M} that span the image space im(H_{(N}_{_{R}}_{×N}_{_{T}}_{^{gNB}}₎^{(gNB→UE)}). This allows the PMI report to capture information about the image space basis vectors under the framework of legacy CSI reporting.

When K in the first technique is 4 or M in the second technique is 4, the UE 704 can determine a precoding matrix for 4 layers of data as follows:

$${W}_{l , m , p , n}^{( 4 )} = \frac{1}{\sqrt{4 {P}_{CSI - RS}}} [ \begin{matrix}{\tilde{v}}_{l , m} & {\tilde{v}}_{l , m} & {\tilde{v}}_{l , m} & {\tilde{v}}_{l , m} \\ {θ}_{p} {\tilde{v}}_{l , m} & - {θ}_{p} {\tilde{v}}_{l , m} & {θ}_{p} {\tilde{v}}_{l , m} & - {θ}_{p} {\tilde{v}}_{l , m} \\ {φ}_{n} {\tilde{v}}_{l , m} & {φ}_{n} {\tilde{v}}_{l , m} & - {φ}_{n} {\tilde{v}}_{l , m} & - {φ}_{n} {\tilde{v}}_{l , m} \\ {φ}_{n} {θ}_{p} {\tilde{v}}_{l , m} & - {φ}_{n} {θ}_{p} {\tilde{v}}_{l , m} & - {φ}_{n} {θ}_{p} {\tilde{v}}_{l , m} & {φ}_{n} {θ}_{p} {\tilde{v}}_{l , m}\end{matrix} ]$$

where

$${φ}_{n} = {e}^{j \frac{π n}{2}}$$

$${θ}_{p} = {e}^{j \frac{π p}{4}}$$

$${μ}_{m} = \{ \begin{matrix}[ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] , & {N}_{2} > 1 \\ 1 , & {N}_{2} = 1\end{matrix}$$

$${\tilde{v}}_{l , m} = {[ \begin{matrix}{μ}_{m} & {e}^{j \frac{4 π l}{{O}_{1} {N}_{1}}} {μ}_{m} & … & {e}^{j \frac{4 π l ( {N}_{1} / 2 - 1 )}{{O}_{1} {N}_{1}}} {μ}_{m}\end{matrix} ]}^{T}$$

O₁ is the oversampling factor in the first spatial dimension of the 2D DFT codebook. O₂ is the oversampling factor in the second spatial dimension of the 2D DFT codebook N₁ is the number of antenna ports in the first spatial dimension of the 2D DFT codebook. N₂ is the number of antenna ports in the second spatial dimension of the 2D DFT codebook.

In other words, O₁, O₂ control the resolution of the spatial quantization by oversampling the spatial dimensions (azimuth and elevation). N₁, N₂ determine the size of the 2D DFT codebook based on the number of antenna ports in each dimension

The indices l, m, p, n correspond to the basis vectors in a codebook configured for the UE 704. The UE 704 determines the values of l, m, p, n based on measurements of the reference signals 720 transmitted by the base station 702 on CC 792. By reporting indices associated with the measured basis vectors, the UE 704 provides enhanced spatial information to the base station 702 about the interference directions to avoid.

In legacy CSI reporting, the indices are restricted to have uniform spacing between the selected basis vectors. For example, the indices for two adjacent basis vectors must be spaced by the oversampling factor O₁.

However, in the techniques described supra, the UE has the flexibility to select any basis vectors without a spacing constraint on the indices. The UE can choose the indices l, m, p, n arbitrarily based on the channel measurements, instead of being limited to, e.g., uniformly spaced values.

This allows the UE to provide a higher resolution representation of the spatial domain by selecting the basis vectors that best match the true channel image space. The removal of the spacing constraint enables better quantization of the angular directions, resulting in a more accurate characterization of the interference space fed back to the base station.

By relaxing the constraints on the indices, the UE has more freedom to select optimal basis vectors that maximize the interference avoidance performance. The base station can then choose more appropriate precoders based on the higher resolution image space feedback.

The CC 791 and CC 792 refer to two component carriers used for communications between the base station 702 and the UE 704 via the repeater 706. The CC 791 and CC 792 can represent non-overlapping frequency bands or subbands that are used for the master-repeater and repeater-UE links.

The CC 791 and CC 792 can be replaced by subband-1 and subband-2, and subband-1 and subband-2 are not overlapped within the same band or in two different bands. This means that the CC 791 and CC 792 can alternatively refer to two non-overlapping subbands within the same frequency band or across two different frequency bands. The subbands take the place of the component carriers but still represent non-overlapping resources.

The CC 791 and CC 792 can be replaced by band-1 and band-2, and band-1 and band-2 are not overlapped. Similarly, the CC 791 and CC 792 can refer to two non-overlapping frequency bands that are used in place of the component carriers. The bands represent different portions of the frequency spectrum allocated for the communications links.

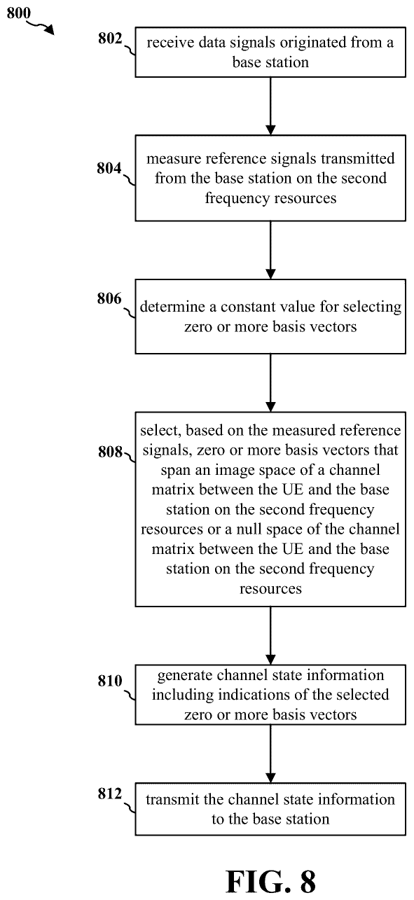

FIG. 8 is a flow chart of a method (process) for reporting channel state information. The method may be performed by a UE (e.g., the UE 704, the UE 250). In operation 802, the UE receives data signals originated from a base station. The data signals are transmitted by the base station on first frequency resources and are not transmitted by the base station on second frequency resources. In certain configurations, the data signals are received on the second frequency resources. In certain configurations, the first frequency resources comprise a first component carrier and the second frequency resources comprise a second component carrier.

In operation 804, the UE measures reference signals transmitted from the base station on the second frequency resources. In operation 806, the UE determines a constant value for selecting zero or more basis vectors. The constant value may be a maximum rank possible between the base station and the UE on the second frequency resources. The constant value may be preconfigured at the UE.

In operation 808, the UE selects, based on the measured reference signals, zero or more basis vectors that span an image space of a channel matrix between the UE and the base station on the second frequency resources or a null space of the channel matrix between the UE and the base station on the second frequency resources. The number of the selected basis vectors may be the constant value.

In certain configurations, to select the zero or more basis vectors, the UE selects the basis vectors from a two-dimensional discrete Fourier transform (2D-DFT) codebook. In certain configurations, each of the zero or more basis vectors is in a form of a rank-1 precoder defined in a codebook. In certain configurations, to select the zero or more basis vectors, the UE is not constrained by predefined spacing restrictions between the selected basis vectors. In certain configurations, the UE further receives, from the base station, a restricted two-dimensional discrete Fourier transform (2D-DFT) codebook oversampled in a spatial domain for channel state information feedback. The zero or more basis vectors may be selected from the restricted 2D-DFT codebook.

In operation 810, the UE generates channel state information including indications of the selected zero or more basis vectors. In certain configurations, the channel state information enables the base station to select precoding vectors that mitigate interference with the UE on the second frequency resources. In certain configurations, the channel state information further includes an indicator for the number of selected basis vectors. In operation 812, the UE transmits the channel state information to the base station.

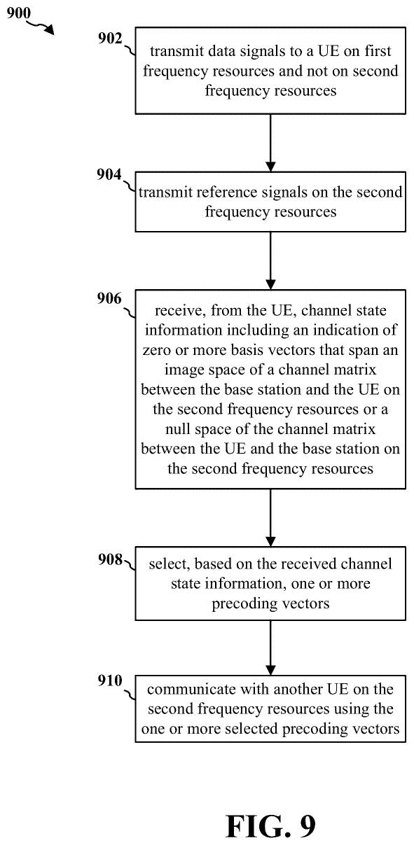

FIG. 9 is a flow chart of a method (process) for determining, based on CSI received from one UE, precoding vectors for transmitting data to another UE. The method may be performed by a base station (e.g., the base station 702, the base station 210). In operation 902, the base station transmits data signals to a user equipment (UE) on first frequency resources and not on second frequency resources. The first and second frequency resources may comprise different component carriers.

In operation 904, the base station transmits reference signals on the second frequency resources. In operation 906, the base station receives, from the UE, channel state information including an indication of zero or more basis vectors that span an image space of a channel matrix between the base station and the UE on the second frequency resources or a null space of the channel matrix between the UE and the base station on the second frequency resources.

The zero or more basis vectors indicated in the channel state information may be selected from a two-dimensional discrete Fourier transform (2D-DFT) codebook. In certain configurations, the base station determines a constant value for the number of basis vectors to be selected and signals this constant value to the UE, restricting the number of selected basis vectors to this constant value. The channel state information received from the UE may also include an indicator for the number of selected basis vectors. The base station may also transmit a restricted 2D-DFT codebook to the UE which is oversampled in the spatial domain for channel state information feedback. The zero or more basis vectors selected by the UE are chosen from this restricted codebook.

In operation 908, the base station selects, based on the received channel state information, one or more precoding vectors. In operation 910, the base station communicates with another UE on the second frequency resources using the one or more selected precoding vectors. By using precoding vectors based on the channel state information received from the first UE, the base station can avoid interfering with the first UE on the second frequency resources]].

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving data signals originated from a base station, wherein the data signals are transmitted by the base station on first frequency resources and not on second frequency resources;
measuring references signals transmitted from a base station on the second frequency resources;
selecting, based on the measured reference signals, zero or more basis vectors that span an image space of a channel matrix between the UE and the base station on the second frequency resources or a null space of the channel matrix between the UE and the base station on the second frequency resources;
generating channel state information including indications the selected zero or more basis vectors; and
transmitting the channel state information to the base station.

2. The method of claim 1, wherein selecting the zero or more basis vectors comprises selecting the basis vectors from a two-dimensional discrete Fourier transform (2D-DFT) codebook.

3. The method of claim 1, wherein each of the zero or more basis vectors is in a form of rank-1 precoder defined in a codebook.

4. The method of claim 1, wherein the data signals are received on the second frequency resources.

5. The method of claim 2, wherein selecting the zero or more basis vectors is not constrained by predefined spacing restrictions between the selected basis vectors.

6. The method of claim 1, further comprising:
determining a constant value for selecting the zero or more basis vectors, wherein the number of the selected basis vectors is the constant value.

7. The method of claim 6, wherein the constant value is a maximum rank possible between the base station and the UE on the second frequency resources.

8. The method of claim 6, wherein the constant value is preconfigured at the UE.

9. The method of claim 1, wherein the channel state information enables the base station to select precoding vectors that mitigate interference with the UE on the second frequency resources.

10. The method of claim 1, wherein the channel state information further comprises an indicator for the number of selected basis vectors.

11. The method of claim 1, further comprising:
receiving, from the base station, a restricted two-dimensional discrete Fourier transform (2D-DFT) codebook oversampled in a spatial domain for channel state information feedback, wherein the zero or more basis vectors are selected from the restricted 2D-DFT codebook.

12. The method of claim 1, wherein the first frequency resources comprise a first component carrier and the second frequency resources comprise a second component carrier.

13. A method of wireless communication of a base station, comprising:
transmitting data signals to a user equipment (UE) on first frequency resources and not on second frequency resources;
transmitting references signals on the second frequency resources;
receiving, from the UE, channel state information including an indication of zero or more basis vectors that span an image space of a channel matrix between the base station and the UE on the second frequency resources or a null space of the channel matrix between the UE and the base station on the second frequency resources;
selecting, based on the received channel state information, one or more precoding vectors; and
communicating with another UE on the second frequency resources using the one or more selected precoding vectors.

14. The method of claim 13, wherein the zero or more basis vectors are selected from a two-dimensional discrete Fourier transform (2D-DFT) codebook.

15. The method of claim 13, further comprising:
determining a constant value for the selecting the zero or more basis vectors and signaling the constant value to the UE, wherein the number of the selected basis vectors is restricted to the constant value.

16. The method of claim 13, wherein the channel state information further comprises an indicator for the number of selected basis vectors.

17. The method of claim 13, further comprising:
transmitting, to the UE, a restricted two-dimensional discrete Fourier transform (2D-DFT) codebook oversampled in a spatial domain for channel state information feedback, wherein the zero or more basis vectors is selected from the restricted 2D-DFT codebook.

18. The method of claim 13, wherein the first frequency resources comprise a first component carrier and the second frequency resources comprise a second component carrier.

19. An apparatus for wireless communication, the apparatus being a user equipment (UE), comprising:
a memory; and
at least one processor coupled to the memory and configured to:
receive data signals originated from a base station, wherein the data signals are transmitted by the base station on first frequency resources and not on second frequency resources;
measure references signals transmitted from a base station on the second frequency resources;
select, based on the measured reference signals, zero or more basis vectors that span an image space of a channel matrix between the UE and the base station on the second frequency resources or a null space of the channel matrix between the UE and the base station on the second frequency resources;
generate channel state information including indications the selected zero or more basis vectors; and
transmit the channel state information to the base station.

20. The apparatus of claim 19, wherein selecting the zero or more basis vectors comprises selecting the basis vectors from a two-dimensional discrete Fourier transform (2D-DFT) codebook.
